(19) United States
(12) Patent Application Publication
(10) Pub. No.: US 2011/0299189 A1
(43) Pub. Date: Dec. 8, 2011

(54) ACTIVE HEAD SLIDER HAVING PIEZOELECTRIC AND THERMAL ACTUATORS

(75) Inventors: Hui Li, Singapore (SG); Kensuke Amemiya, Singapore (SG)

(73) Assignee: Hitachi Asia Limited, Singapore (SG)

(21) Appl. No.: 12/794,137

(22) Filed: Jun. 4, 2010

(51) Int. Cl. G11B 21/02

(52) U.S. Cl. 360/75; G9B/21.003

(57) ABSTRACT

An active head slider for a use in a Hard Disk drive having first and second actuators. The first actuator deforming a portion of a slider body that includes a read/write head to reduce the flying height of the portion over a disk. The second actuator forming a protrusion in a bottom surface of the slider body that includes an end of the read/write head to further reduce the flying height of the read/write head. Preferably, the first actuator is a piezoelectric actuator and the second actuator is one or more thermo actuators.

### FIELD OF THE INVENTION

This invention relates to a Hard Disk Drive (HDD). More particularly, this invention relates to a slider that includes a read/write head that is positioned over a disk to read and write data. Still more particularly, this invention relates to a slider that includes a piezoelectric actuator and a thermo actuator for controlling the flying height of the slider over a disk in a HDD.

### SUMMARY OF THE PRIOR ART

Many electronic devices include a HDD to store the large amount of data needed to perform the functions of the device. As these electronic devices become smaller in size, the size of the HDD must also be reduced. The reduction in size of the HDD requires that a slider that includes the read/write heads of the HDD also be reduced in size. The reduced size of the head makes the head more susceptible to shear forces caused by an air flow in the HDD that is caused by the rotating disk.

One desire of designers of HDDs is to reduce the flying height of a read/write head over the disk. Designers want to reduce the flying height to reduce alignment problems with heads and the tracks to provide more accurate reading and writing of the data. However, the reduction in flying height must be balanced with the need to reduce the amount of sheer forces acting on the slider as the sheer forces acting on the slider may cause various alignment problems that the reduction in flying height is attempting to reduce. Thus, those skilled in the art are constantly looking at ways to reduce the flying height of the slider head while minimizing the effects of sheer forces on the slider head.

Those skilled in the art have proposed using actuators to reduce the flying height of a portion of the slider body or head while an operation is being performed and then having the slider body or head move back to an original configuration during movement. One type of actuator proposed is a thermo actuator. A thermo actuator is a material formed into a slider body that heats the surrounding material in the head in response to a current applied to the actuator. The heated material then expands causing a deformation in the body that reduces the flying height of the head over the disk below. These actuators are very effective. However, the amount of time needed for a thermo actuator to heat the surrounding material is often too long to be effective during disk operations.

A second proposed actuator is piezoelectric actuator. A piezoelectric actuator is a layer of piezoelectric material formed in the slider body between two electrodes. A current is applied to the piezoelectric material that causes the material to expand. The expansion of the material causes a portion of the slider body to deform reducing the flying height of the head within the deformed portion of the body. Piezoelectric actuators have a better response time than thermo actuators. However, the deformation caused by conventional PZTs is often unacceptably large and causes the airflow between the slider and the disk to be compressed, limiting the reduction of flying height. Furthermore, the deformation varies the shear force on the slider, altering the flying altitude of the slider.

To overcome these problems, those skilled in the art have foreseen a combination of piezoelectric and thermo actuators to overcome the problems with each type of actuator individually.

For example, US Patent Publication Number 2008/0074797, titled “Storage Medium Drive Capable of Reducing Wiring Related to Head Slider” in the name Ika et al. published Mar. 27, 2008; US Patent Publication Number US 2008/017919, titled “Disc Drive Actuator” in the name of White et al. published on Jul. 24, 2008; US Patent Publication Number 2001/0033546, titled “Flying Optical Recording/Playback Head and Method for Controlling the Flying Height” in the name Katayama published Oct. 25, 2001; European Patent Application Publication Number 0242597 on behalf of IBM published Oct. 28, 1987; U.S. Pat. No. 7,388,726 titled “Dynamically Adjustable Head Disk Spacing slider Using Thermo Expansion” issued to McKenzie et al. issued Jun. 17, 2008; and U.S. Pat. No. 6,950,266 titled “Active Fly Height Control Crown Actuator” issued to McCaslin et al. issued Sep. 27, 2005, all discuss the possibility of the use of a combination of thermo and piezoelectric actuators. However, these documents are all silent on a configuration in the slider body that will allow the combination to effectively reduce the flying height of the head while having the response time desired to perform read and/or write operations.

Thus, those skilled in the art are constantly striving to design for a configuration of a slider body that incorporates thermo and piezoelectric actuators in manner that allows the flying height of the head to be controlled within the time needed for the operation that is of an acceptable size for use in current HDDs.

### SUMMARY OF THE INVENTION

The above and other problems are solved and an advance in the art is made by a slider and actuator system in accordance with this invention. A first advantage of this invention is that the use of two actuators reduces the flying height of a head over a rotating disk while read and/or write operations are being performed. A second advantage of this invention is that response time for the actuators is reduced through the use of a combination of actuators. A third advantage of this invention is the increased rigidity and stiffness of the flying head.

In accordance with this invention, a slider for an HDD is configured in the following manner. The slider includes a slider body. Preferably, the slider body is substantially 1.25 millimeter by 1 millimeter by 0.3 millimeter in dimension. The slider body has a leading surface, a trailing surface, a bottom surface and a top surface. A head is formed in the slider body in a portion of the body proximate to the trailing surface. The head may include a shield, a pole, and write coils. Preferably the shield and poles are formed of a Ni—Fe compound while the write coils are formed of copper (Cu). The slider body also includes a first actuator that causes the portion of the body including the head to deform to reduce the flying height of the portion. A second actuator in the body then causes a protrusion from the bottom surface of the portion of the slider body that includes the head. The protrusion includes an end of the head to further reduce the flying height of the head over the disk.

In accordance with some embodiments of this invention, the first actuator is a piezoelectric actuator. Preferably, the piezoelectric actuator includes a first electrode formed in a substrate in the slider body proximate to the leading surface of the body, a layer of piezoelectric material formed on the first electrode in the substrate and second electrode formed between the layer of piezoelectric material and a base coat proximate to the portion of the body including the head. Preferably, the substrate is Al₂O₃—TiC, the piezoelectric material is Tokin N-21 and the base coat is Al₂O₃.

The electrodes apply a current to the layer of piezoelectric material. The current causes the piezoelectric material to expand. The expansion of the piezoelectric material causes the portion of the body including the head to deform. The deformation of the portion reduces the flying height of the portion over the disk.

In accordance with an embodiment of the invention in which the slider body is substantially 1.25 millimeter by 1 millimeter by 0.3 millimeter in dimension, the piezoelectric material is approximately 200 μm in thickness. In accordance with this embodiment, a drive voltage of 30 volts is applied across the layer of piezoelectric material to cause the portion of the slider body to deform towards the disk with a bottom edge of the trailing surface deformed approximately 27.34 nanometers towards the disk.

In accordance with some embodiments of this invention, the second actuator is a heat actuator element. In accordance with some of these embodiments, the heat actuator element includes a thermo actuator. The thermo actuator is formed in the portion of the body proximate to the head. Current is applied to the thermo actuator that causes the thermo actuator to heat the material around the actuator including the material in at least one end of the head proximate to the bottom surface of the body. The heating of the material causes the material to expand and form a protrusion in the bottom surface of the body. The protrusion includes the end of the read/write head to reduce the flying height of the head over the disk.

In accordance with some embodiments of this invention, the heat actuator element includes multiple thermo actuators formed in the portion of the slider body proximate to the head. In accordance with some particular embodiments, a first thermo actuator is formed at a first distance from the bottom surface of the slider body proximate to a first side of the head and a second thermo actuator is formed at a second distance from the bottom surface of the slider body proximate to a second side of the head. Preferably the first and second distances are not equal and the first and second actuators are positioned so as to heat the head along substantially the entire length of the head. Furthermore, the first and second actuators may each be formed to have a heating material proximate to the head and an insulating material distal from the head to prevent other components of the portion of the slider body from being heated to localize the protrusion proximate to the head. In the preferred embodiment, 10 milliwatts of power is applied to each of the first and second thermo actuators to cause a protrusion including an end of the head to form that protrudes substantially 9.70 nanometers from the bottom surface of the portion of the slider body.

### BRIEF DESCRIPTION OF THE DRAWINGS

The above and other features and advantages of this invention are described in the Detailed Description set forth below and the following drawings:

FIG. 1, which illustrates components of a HDD including a slider configured in accordance with invention;

FIG. 2, which illustrates a slider in accordance with an embodiment of this invention;

FIG. 3, which illustrates a cross sectional view of the slider shown in FIG. 2 along plane A;

FIG. 4, which illustrates a view of the slider shown in FIG. 2 when a first actuator has been activated in accordance with an embodiment of this invention;

FIG. 5, which illustrates a view of the slider shown in FIG. 2 when the first actuator and a second actuator have been activated in accordance with an embodiment of this invention;

FIG. 6, which illustrates an end view of a portion of the slider shown in FIG. 2 with a protrusion formed by the second actuator in accordance with an embodiment of this invention;

FIG. 7, which illustrates a flow diagram for a process for operating a slider in accordance with the embodiment shown in FIG. 2;

FIG. 8, which illustrates a graph comparing deformation of a slider to the distance to the sliders trailing edge using various configurations of actuators;

FIG. 9, which illustrates a graph comparing the air pressure to the distance from the slider using various configurations of actuators; and

FIG. 10, which illustrates a graph comparing flying height to distance from a trailing edge of slider for various configurations of actuators.

### DETAILED DESCRIPTION

This invention relates to Hard Disk Drives (HDD). More particularly, this invention relates to a slider that includes a read/write head that is positioned over a disk to read and write data. Still more particularly, this invention relates to a slider that includes a piezoelectric actuator and a thermo actuator for controlling the flying height of the slider over a disk in a HDD.

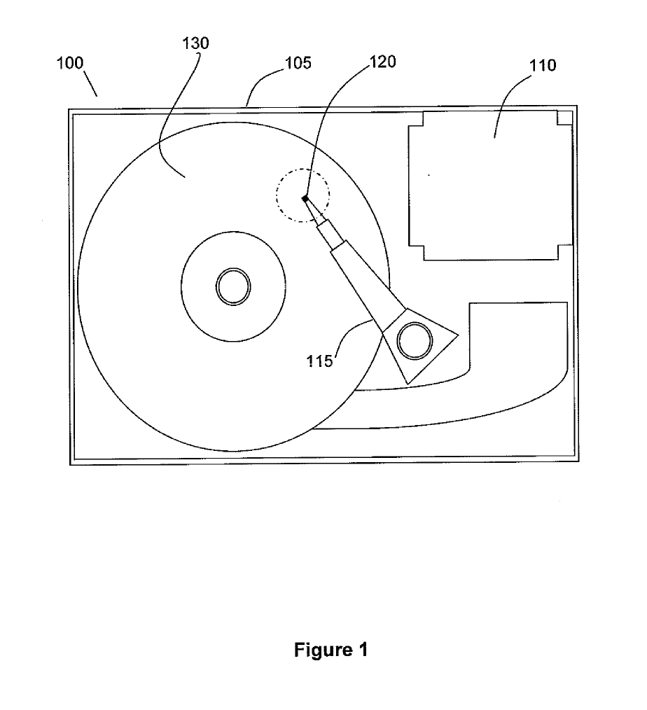

FIG. 1 illustrates HDD 100 that incorporates a slider head in accordance with an embodiment of this invention. HDD 100 is enclosed in housing 105. Inside housing 105, disk 130 made of a media that data may be written to and read from is mounted on a rotating platform (Not Shown). Slider 120 includes read and/or write heads for writing data to and reading data from disk 130. Articulated arm 115 is positioned over disk 130 and has slider 120 affixed to a free end of articulated arm 115 and is movable to place slider 120 in certain position over disk 130 to read data from or write data to a particular track of disk 130. Electronics 110 includes all of the circuitry for controlling the process of reading data from and writing data to disk 130. In particular, electronics 110 includes the circuitry for controlling the motor (not shown) for rotating disk 130; circuitry for positioning slider 120 in the proper position over disk 130 by articulating arm 115; and circuitry for controlling slider 120. One skilled in the art will recognize that only those components of HDD 100 that are needed to understand the invention are described. A complete description of HDD 100 is omitted for brevity.

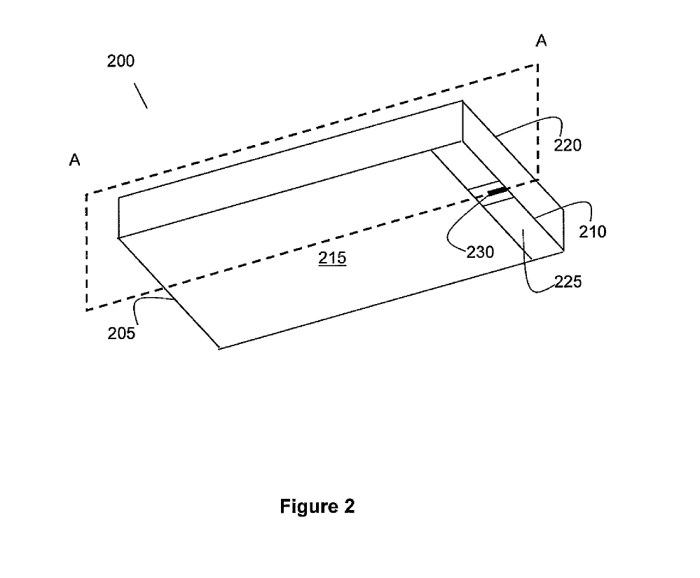

FIG. 2 is an enlarged perspective view of slider 120. Preferably, slider 120 includes slider body 200 having dimensions of 1.25 millimeter by 1 millimeter by 0.3 millimeter. However, slider body 200 may have other dimensions without departing from this invention. Trailing surface 210 is at one end of slider body 200 that faces away from the oncoming of rotation disk 130. Slider body 200 further includes leading surface 205 that faces the oncoming rotation of disk 130, top surface 220, and bottom or air bearing surface 215. Slider 120 is a structure formed by depositions of layers of material with base layers proximate to leading surface 205 and the top layer are formed proximate to trailing surface 210.

Slider body 200 also includes portion 225 proximate to trailing surface 210 that includes read/write head 230 that is a structure formed within portion 225. One skilled in the art will note that only one read/write head 230 is included in portion 225 in this embodiment of the invention. However, more than one read/write head may be formed within section 225 without departing from this invention.

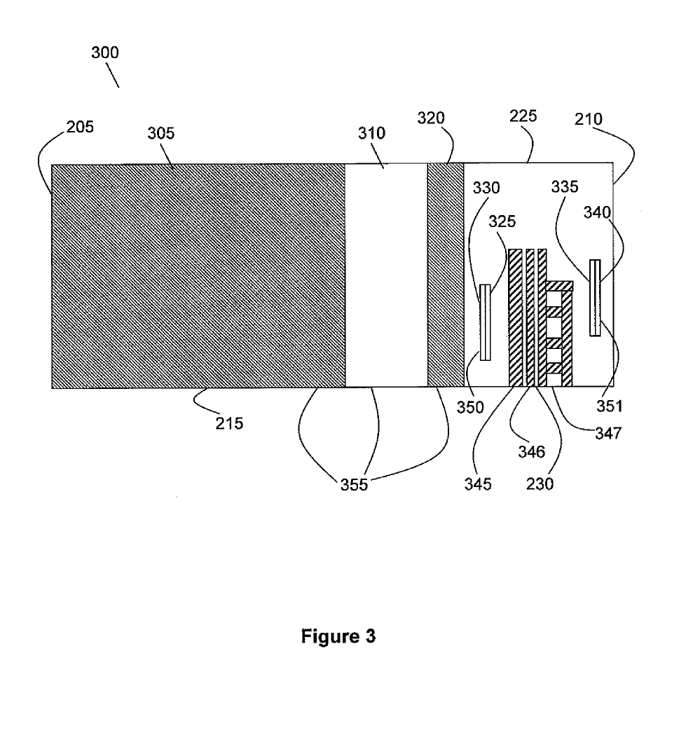

FIG. 3 illustrates a cross sectional view of slider body 200 of slider 120 along plane A shown in FIG. 2. Slider body 200 includes substrate 305 formed proximate to leading surface 205. Preferably, substrate 305 includes at least a layer of Al₂O₃—TiC at an end of substrate 305 that is opposite leading surface 205. In this embodiment, first actuator 355 is formed of a first electrode formed in substrate 305, a layer of piezoelectric material 310 formed on substrate 305 and a second electrode formed in base coat layer 320 that is formed on layer of piezoelectric material 310. Further, one skilled in the art will recognize that the second electrode in the substrate adjacent the first electrode without departing from this invention. First actuator 355 causes portion 225 of slider 120 to deform or bend downwards towards disk 130. Thus the flying height of portion 225 over disk 130 is reduced. The deformation also changes the flight attitude of slider body 200.

In the illustrated embodiment, layer of piezoelectric 310 is formed of Tokin N-21 and is approximately 200 μm in thickness at a distance of 92.8 μm from trailing surface 210. One skilled in the art will recognize that the exact piezoelectric material used and the thickness used will be design choices based upon the requirements of the system. Base coat 320 is then formed over layer of piezoelectric material 310. Preferably, base coat 320 is Al₂O₃.

In accordance with this described embodiment of the invention, base coat 320 and substrate 305 act as electrodes to apply a current to layer piezoelectric material 310. In response to the current being applied, layer of piezoelectric material 310 deforms. The resulting deformation from applying current is determined by the following equation:

Δx=d₁₅*V

where:
V is the drive voltage;
d₁₅ is the piezoelectric charge constant.

In the embodiment described herein, including a layer 310 of Tokin N-21 that is approximately 200 μm thick, a drive voltage of 30 volts results in a deformation of a maximum of 27.34 nm towards disk 130. One skilled in the art will recognize that other configurations of a piezoelectric actuator may be used without departing from this invention.

Slider body 200 includes read/write head 230 formed within portion 225. Read/write head 230 includes structures formed in the layers of portion 225. The structures include shield 345, pole 346, and coils 347. Preferably, shield 345 and pole 346 are structures formed in portion 225 proximate to bottom surface 215. However, other configurations may be used without departing from this invention. Preferably shield 345 and pole 346 are Ni—Fe material as is common in the art. Coils 347 are also formed proximate to bottom surface 215 in portion 225 and are preferably made of Cu.

At least one second actuator is located proximate to read/write head 230. The second actuator causes a protrusion to form from bottom surface 215 that includes an end of read/write head 230. In the illustrated embodiment, the second actuator is thermo actuator 350 formed on one side of read/write head 230. Thermo actuator 350 includes a heat element 325 formed proximate to read/write head 230 and insulating element 330 formed distal read/write head 230. Current is applied to heat element 325 which causes heat element 325 to raise the temperature of material adjacent heat element 325. The rise in temperature causes the material to expand and form a protrusion from bottom surface 215. Since heat element 325 is proximate to read/write head 230, the protrusion includes an end of read/write head 230.

In some embodiments, the second actuator includes more than one actuator. In particular, the embodiment shown in FIG. 3 includes two thermo actuators 350, 351. Thermo actuators 350 and 351 are on opposing sides of read/write head 230. Furthermore, first thermo actuator 350 is formed at first distance from bottom surface 215 in portion 225 and second thermo actuator 351 is formed at a second distance from bottom surface 215 in portion 225. First and second thermo actuators 350, 351 are offset from one another in order to heat the entire length of read/write head 230 to increase the size of the protrusion and localize the heated material in portion 225.

In the illustrated embodiment, first thermo actuator 350 is formed 1.22 μm from bottom surface 215 in portion 225 and second thermo actuator 351 is formed 9.72 μm from bottom surface 215 in portion 225. Each of the insulating elements 330, 340 has a thickness of 0.16 μm. In the illustrated embodiment, 10 milliwatts of power is applied to each thermo actuator 350, 351 to cause a protrusion of about 9.70 nanometers. The application of current causes a temperature increase of approximately 155 degrees Celsius around each thermo actuator and increase of 27.95 degrees Celsius of bottom surface 215 around read/write head 230. When first actuator 355 and second actuator 350, 351 are applied, the flying height of head 230 is reduced to 3.18 nm compared to 8.40 nm of a conventional slider. Furthermore, the pitch angle is significantly reduced from 97.66 μrad to 57.07 μrad.

In a preferred embodiment, the flying height is reduced without substantial variation to the pitch angle of the slider. Varying the pitch angle by too much causes turbulence in the air between the slider and the disk. The turbulence, in turn, causes the slider to oscillate. The variation in the pitch angle of the slider is reduced through the usage of a combination of PZT and thermal actuators.

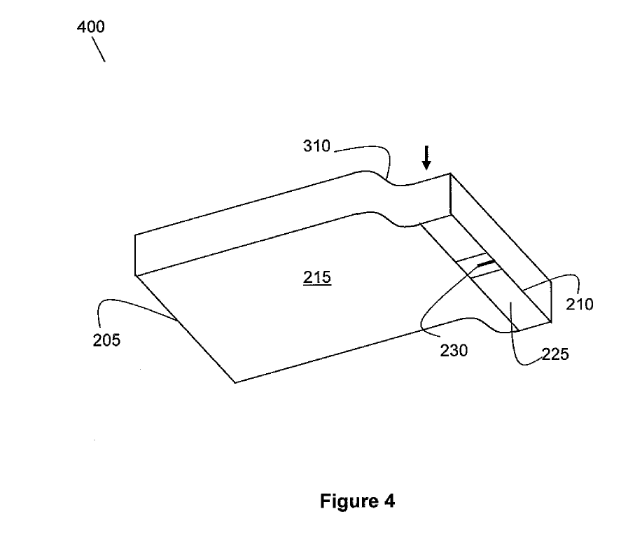

FIG. 4 is a perspective view of slider body 200 while first actuator 355 is activated in the illustrated embodiment. As shown, layer of piezoelectric material 310 deforms in response to a current being applied. In response to the current, layer 310 expands causing portion 225 proximate to trailing surfaces 210 to deform towards disk 130 (as indicated by the arrow). This reduces the flying height of portion 225 which is now non-planar with the remainder of slider body 200.

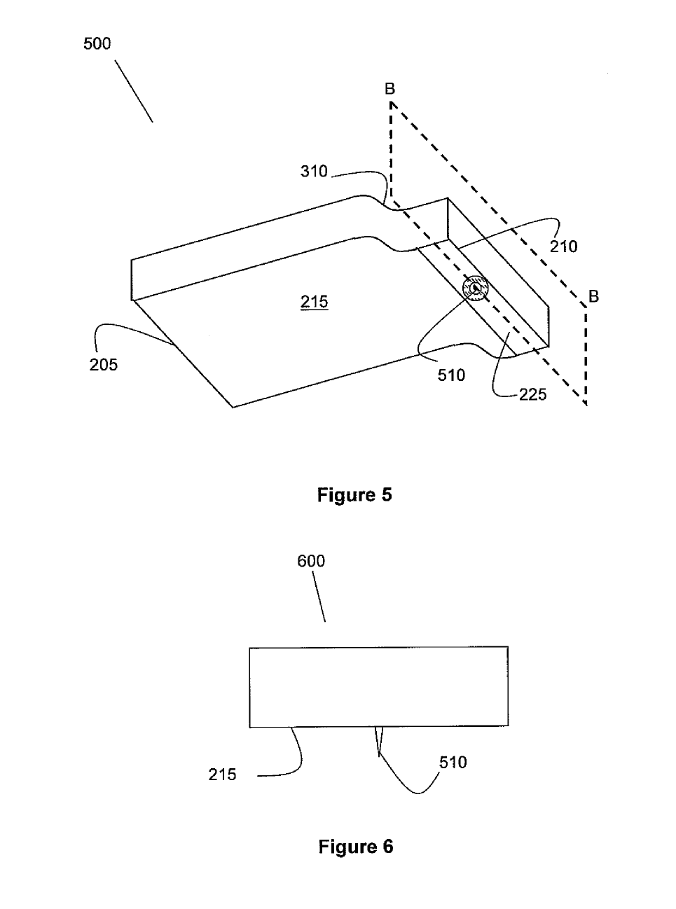

FIG. 5 illustrates a perspective view of slider body 200 when first actuator 355 and second actuators 350, 351 are activated. As shown, layer of piezoelectric material 310 deforms in response to a current being applied. In response to the current, layer 310 expands causing portion 225 proximate to trailing surface 210 to deform towards disk 130. The deformation of portion 225 reduces the flying height of portion 225 which is now non-planar with the remainder of body 200. To further reduce the flying height of read/write head 230, current is applied to the second actuator. In the illustrated embodiment, the second actuator includes first and second thermo actuators 350,351. The actuators heat the material along substantially the entire length of read/write head 230 that causes a protrusion from bottom surface 215 that includes an end of read/write head 230. The protrusion formed by the heating of the material of read/write head 230 is shown in greater detail in FIG. 6 that shows a cross sectional view of portion 215 along plane B shown in FIG. 5. As can be seen, the protrusion extends outward from bottom surface 215 and includes material from an end of read/write head 230.

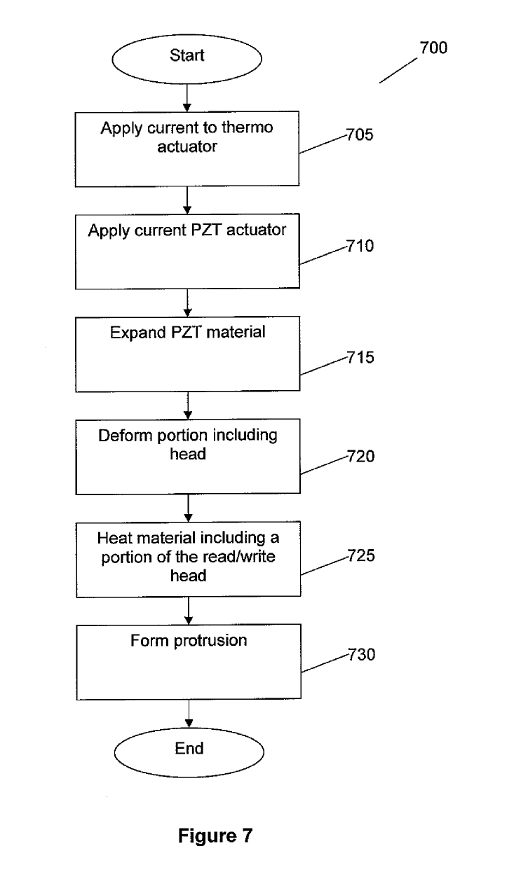

FIG. 7 illustrates a flow diagram of process 700 for reducing the flying height of portion 225 of slider body 200 in accordance with an embodiment of this invention. Process 700 begins in step 705 with current is applied to first thermo actuator 350 and second thermo actuator 351 in step 705. After or concurrently with step 705, a voltage is applied across layer of piezoelectric material 310 by introducing current between substrate 305 and base coat 315 acting as electrodes in step 710. The voltage causes layer of piezoelectric material 310 to expand in step 715. The expansion of layer 310, in turn, causes a deformation of portion 225 in step 720. The deformation of portion 225 reduces the flying height of portion 225 over disk 130. The current applied to the thermo actuators causes thermo actuators 350 and 351 to heat the material surrounding actuators 350 and 351 including the material in read/write head 230 in step 725. The heated material expands causing a protrusion from bottom surface 215 of portion 225 to form in step 730. The protrusion includes material from an end of read/write head 230. Thus, the flying height of read/write head 230 is further reduced. After step 730, process 700 ends.

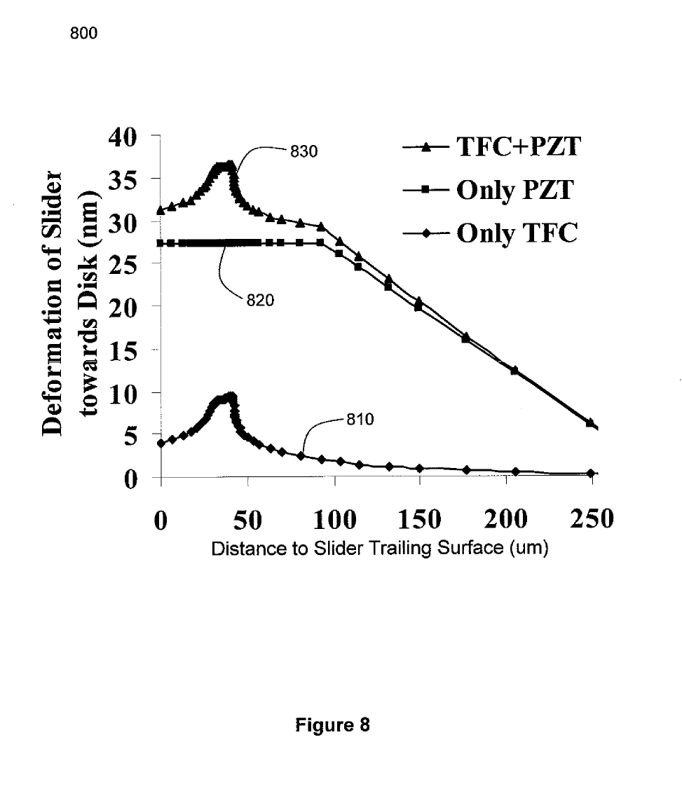

FIG. 8-10 show graphs of simulated results from the use of the actuators in accordance with a preferable configuration of components and current applied in accordance with the illustrated embodiment of the present invention. FIG. 8 illustrates graph 800 which compares the deformation towards disk 130 of portion 225 of slider body 200 at varying distances from trailing surface 210. Line 810 represents the flying height of the distance when only the thermo actuators in accordance with this invention are activated. As can be seen from line 810, the deformation greatly increases at approximately 20 to about 50 μm from surface 210. This represents the protrusion formed in bottom surface 215. As can be further seen, the deformation only increases at most to about 10 nm. Line 820 represents the results when only layer of piezoelectric material is activated. As can be seen, the deformation is constant at about 27 nm from 0.0 to about 100 μm in distance from trailing surface 210. This shows that the deformation is greatest at the far surface and is reduced where portion 225 and the first actuator join. Line 830 is the deformation that occurs when both piezoelectric and thermo actuators are activated. As shown, the deformation in portion 225 at about 20 to 50 μm from trailing surface 210 is much greater than either actuator individually provides. This area represents the protrusion and as can be seen, the deformation at the protrusion is approximately 37 nm. Thus, the flying height of read write/head 230 is greatly reduced due to the greater deformation caused by the action of the two actuators.

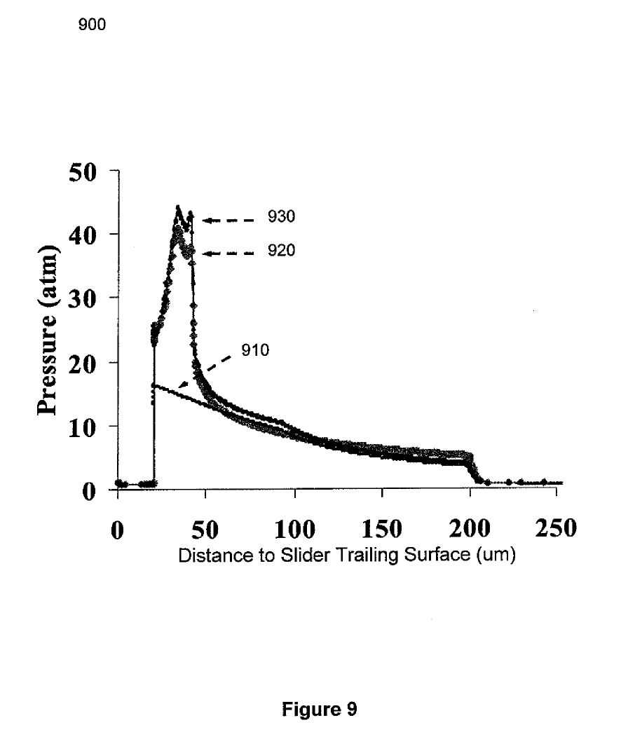

FIG. 9 illustrates graph 900 showing the air pressure applying shear forces to bottom surface 215 of portion 225 at varying distances from trailing surface 210. Line 910 represents plots of the results from activation of only the first actuator by applying current to layer of piezoelectric material 310. As can be seen from line 910, there is very little pressure proximate to trailing edge 210. The pressure then increases at about 50 μm from trailing surface 210 where head 230 is located and then the pressure steadily declines as the distance from trailing surface 210 increases. Line 920 shows the pressure as a protrusion is formed from activating only second actuators 350,351. As shown by line 920, the pressure greatly increases at the area of the protrusion about 20 to 50 μm from trailing surface 210 then the pressure steadily lessens as the distance from trailing surface 210 increases. Line 930 shows the pressure when both actuators are activated. As can be seen from line 930, there is not a significant increase of pressure as compared to when only the thermo actuators are activated.

Furthermore, it is known from experimentation that the maximum pressure exerted on a bottom or air bearing surface of a conventional slider is 1.65*10⁶ Pa and is exerted near the trailing edge of a rear pad. However, the maximum pressure exerted on bottom surface 215 of slider body 200 in accordance with this invention is 4.47*10⁶ Pa which is 2.7 time greater the convention slider. The difference arises because the trailing part of the slider body 200 is vertically deformed towards the disk owing to the deformation caused by layer of piezoelectric material 310 and thermal protrusion. However, the pressure profile of slider body 200 is significantly narrower and sharper due to the protrusion.

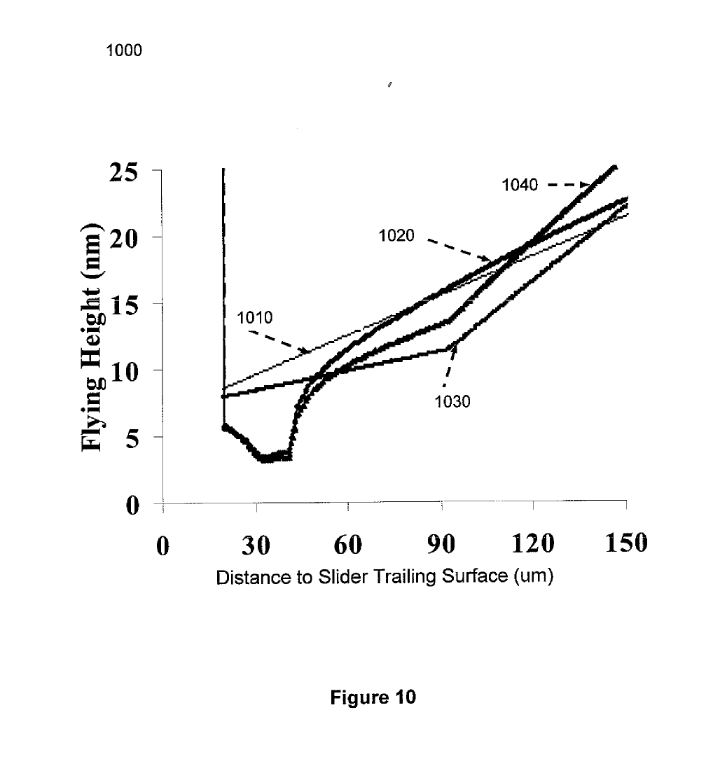

FIG. 10 shows the flying height of bottom surface 215 at varying distances from trailing surface 210 using the various configurations of actuators. Line 1010 shows conventional slider in which the flying height steadily increases as the distance from the trailing surface increases. Line 1030 shows the flying height of the slider body when only the first piezoelectric actuator is activated. As can be seen, the activation of the piezoelectric actuator reduces the flying height significantly across the entire bottom surface as the distance from the trailing surface increases. Line 1020 shows the flying height when only thermo actuators are activated. In this case, a significant reduction is made at the protrusion (about 20 to 50 μm from the trailing surface). However, the rest of slider body 200 is at about the same flying height as a conventional slider body. Line 1040 shows the activation of both actuators. In this case, the flying height of the area about the protrusion is the same as when only the thermo actuators are activated. However, the flying height of the remainder of the body is also significantly reduced further than if the piezoelectric actuator were activated alone.

Having described the invention, and a preferred embodiment thereof, what we claim as new, and secured by Letters Patent is:

1. An active-head slider for a hard disk drive, said slider comprising:
a slider body having a top surface, a bottom surface, a leading surface, a trailing surface, a first side, and a second side;
a head for reading and writing data formed in a portion of said slider body proximate to said trailing surface of said slider body;
a first actuator element that controls deformation of said portion of said slider body proximate to said trailing surface that includes said head to reduce a flying height of said portion including said head over a disk rotating in said hard disk drive; and
a second actuator element that causes a protrusion from said bottom surface of said slider body that includes an end of said head to reduce said flying height of said head over said disk.

2. The active head slider of claim 1, wherein said first actuator element comprises: a piezoelectric actuator.

3. The active head slider of claim 2, wherein said piezoelectric actuator is formed between said portion of said slider body including said head and said leading surface of said slider.

4. The active head slider of claim 3, wherein said piezoelectric actuator comprises:
a first electrode formed in a substrate of said body proximate to said leading surface;
a layer of piezoelectric material formed on said substrate; and
a second electrode formed on a basecoat layer formed on said piezoelectric layer, wherein said portion of said slider body including said head is formed on said basecoat layer.

5. The active head slider of claim 4, wherein said substrate comprises Al₂O₃—TiC.

6. The active head slider of claim 4, wherein said layer of piezoelectric material comprises Tokin N-21.

7. The active head slider of claim 4, wherein said body is substantially 1.25 millimeter by 1 millimeter by 0.3 millimeter and said layer of piezoelectric material is approximately 200 μm in thickness.

8. The active head slider of claim 7, further comprising:
circuitry for applying a drive voltage of 30 volts to said layer of piezoelectric material to cause said portion to deform towards said disk with a bottom edge of said trailing surface deformed approximately 27.34 nanometers towards said disk.

9. The active head slider of claim 4, wherein said base coat layer comprises Al₂O₃.

10. The active head slider of claim 1, wherein said second actuator element comprises: a heat actuator element proximate to said head in said portion of said slider body.

11. The active head slider of claim 10, wherein said heat actuator element comprises: a thermo-actuator formed in said portion of said slider body proximate to said head that heats material of said head to cause expansion of said head causing an end of said head to protrude from said bottom surface of said portion of said slider element.

12. The active head slider of claim 11, wherein said thermo-actuator comprises: a heat element; and an insulation element.

13. The active head slider of claim 10, wherein said heat actuator element comprises:
a plurality of thermo actuators formed in said slider body proximate to said head and that heat material of said head to cause expansion of said head causing an end of said head to protrude from said bottom surface of said portion of said slider element.

14. The active head slider of claim 13, wherein said plurality of thermo-actuators comprise:
a first thermo-actuator formed proximate to a first side of said head at a first distance from said bottom surface of said portion of said slider body; and
a second thermo-actuator formed proximate to a second side of said head at a second distance from said bottom surface of said slider body.

15. The active head slider of claim 14, wherein said first distance and said second distance are different from one another such that said first thermo-actuator and said second thermo-actuator apply heat along substantially an entire length of said head.

16. The active head slider of claim 15, further comprising:
circuitry configured to apply 10 milliwatts of power to said first thermo-actuator and 10 milliwatts of power to said second thermo-actuator to cause said head to protrude substantially 9.70 nanometers from said bottom surface of said portion of said slider body.

17. The active head slider of claim 13, wherein each of said plurality of thermo-actuators comprises:
a layer of heating material proximate to said head to heat said material of said head; and
a layer of insulating material distal from said head to shield material in said portion of said slide body from heat generated by said layer of heating material.

18. The active head slider of claim 1, wherein said head comprises:
a shield;
a pole; and
write coils.

19. The active head slider of claim 18, wherein said shield comprises Ni—Fe.

20. The active head slider of claim 18, wherein said pole comprises Ni—Fe.

21. The active head slider of claim 15, wherein said write coils comprise Cu.

22. A method of operating an active head slider of a disk drive, wherein said slider has a slider body with a top surface, a bottom surface, a leading surface, a trailing surface, a first side, and a second side; a head for reading and writing data formed proximate to in a portion of said slider body proximate to said trailing surface of said slider body, said method comprising:
deforming said portion of said slider body including said head to reduce a flying height of said portion over a disk; and
forming a protrusion from said bottom surface of said portion including an end of said head to reduce the flying height of said head over said disk.

23. The method of claim 22, wherein deforming said portions of said slider body comprises: activating a first actuator that causes said deforming of said portion.

24. The method of claim 23, wherein activating said first actuator comprises activating a piezoelectric actuator by expanding a layer of piezoelectric material in said first actuator.

25. The method of claim 24, wherein
said piezoelectric actuator includes a first electrode formed in said substrate; a layer of piezoelectric material and a second electrode form in a base coat, and
wherein expanding said layer comprises: applying a current to said layer of piezoelectric material through said first electrode formed in said substrate and said second electrode formed in said base coat.

26. The method of claim 25,
wherein said layer of piezoelectric material is approximately 200 μm in thickness and
wherein applying said current comprises applying a drive voltage of 30 volts to said layer of piezoelectric material to cause said portion to deform towards said disk with a bottom edge of said trailing surface deformed approximately 27.34 nanometers towards said disk.

27. The method of claim 22, wherein forming said protrusion comprises activating a second actuator that causes said protrusion to form.

28. The method of claim 27,
wherein said second actuator comprises a thermo-actuator proximate to said head, and
wherein activating said second actuator comprises applying a current to said thermo-actuator to cause said thermo-actuator to heat material in said head.

29. The method of claim 27,
wherein said second actuator comprises a plurality of actuators formed around said head, and
wherein activating said second actuator comprises applying current to each of said plurality said thermo-actuators to cause said plurality of thermo-actuators to heat material in said head.

30. The method of claim 29,
wherein said plurality of thermo-actuators includes a first thermo actuator formed on a first side of said head and a second thermo-actuator formed on a second side of said head, and
wherein applying current comprises: applying current to said first thermo-actuator and said second thermo-actuator to heat said material in said head.

31. The method of claim 30, wherein
said first thermo-actuator is formed in said portion at a first distance from said bottom surface of said portion of said slider body, and
said second thermo-actuator is formed in said portion at a second distance from said bottom surface of said portion of said slider body,
said method further comprising heating said material head along substantially an entire length of said head.

32. The method of claim 31, wherein applying current comprises: applying 10 milliwatts of power to said first thermo-actuator and 10 milliwatts of power to said second thermo-actuator to cause said head to protrude substantially 9.70 nanometers from said bottom surface of said portion of said slider body.
